(19) United States
(12) Patent Application Publication
(10) Pub. No.: US 2007/0130528 A1
(43) Pub. Date: Jun. 7, 2007

(54) METHOD AND SYSTEM FOR SIMULTANEOUS TESTING OF APPLICATIONS

(76) Inventor: Peter Johnson, Chandlers Ford (GB)

Correspondence Address: IBM CORPORATION;INTELLECTUAL PROPERTY LAW, 11400 BURNET ROAD, AUSTIN, TX, 78758, US

(21) Appl. No.: 11/459,431

(22) Filed: Jul. 24, 2006

(30) Foreign Application Priority Data
Nov. 8, 2005 (GB) 0522734.3

(51) Int. Cl. G09G 5/00; G06F 3/00

(52) U.S. Cl. 715/761; 345/1.1; 700/4; 709/208

(57) ABSTRACT

A method and system for simultaneous testing of applications are provided. A first interface (119) for an application (102) is provided on a first configuration (110) of software and/or hardware. At least one further interface (129) for an application (102) of the same form as the application of the first interface (119) is provided on a different configuration (120) of software and/or hardware. An input device (130) enables a user to input an event to the first interface (119). The input event is captured and sent to the at least one further interface (129) in parallel.

### RELATED APPLICATIONS

This application claims benefit of priority to Patent Application No. GB 0522734.3, filed in the United Kingdom on Nov. 8, 2005, which is incorporated herein by reference.

### FIELD OF THE INVENTION

This invention relates to the field of testing of computer software applications. In particular, the invention relates to simultaneous testing of applications running on different configurations of software and/or hardware.

### BACKGROUND OF THE INVENTION

A new software application running under a Graphical User Interface (GUI) must be tested for each configuration of software and/or hardware on which it may be provided. For example, different configurations may use different processors, operating systems, databases, web servers, network protocols, etc.

In general, the testing of GUI applications requires that the application under test is sent a series of keyboard and mouse events. The test is designed such that for every input event it is known what the correct output event should be. Manual testing is required with human interaction which makes the testing process time consuming and expensive. This is particularly true where a test must be run multiple times, once for each configuration.

When testing a GUI application which is being produced by different software/hardware configurations it becomes evident that the test operations that are performed for a test on one of the configurations are identical to the test operations performed on another configuration. This means that the amount of testing to be carried out is multiplied by the number of different configurations on which the application under test is provided.

It is known to record test operations so that these can be played back for a subsequent test on the same application provided on a different configuration. However, this has the disadvantage that the tests cannot be run concurrently and the test operator must monitor the outputs of the test repeated for each configuration.

### SUMMARY OF THE INVENTION

According to a first aspect of the present invention there is provided a method for simultaneous testing of applications, comprising: receiving a user input event for a first interface; capturing the event and sending the input event to one or more other interfaces in parallel; wherein the interfaces are for a single form of application provided on different configurations of software and/or hardware.

In a preferred embodiment, the interfaces are graphical user interfaces (GUIs). The GUIs may be provided on browser application sessions at a user system. The user system may communicate via a network with each of the applications provided on different configurations. The GUIs may be provided on web browser application sessions pointing to different Universal Resource Locators (URLs) for the applications on different configurations.

In one embodiment, the one or more other interfaces are displayed to the user, for example, as windows. However in an alternative embodiment, the one or more other interfaces may be virtual interfaces which are not displayed to the user. A virtual interface may be rendered as a display when a difference between the outcome of the event on the first interface and the virtual interface is detected.

Input events to the first interface may be locked until the input event has returned for all the interfaces. An input event may be returned in an interface when a content of the interface is detected. Logs may be maintained of input events and processing on each interface.

According to a second aspect of the present invention there is provided a system for simultaneous testing of applications, comprising: a first interface for an application provided on a first configuration of software and/or hardware; at least one further interface for an application of the same form as the application of the first interface provided on a different configuration of software and/or hardware; an input device for inputting a user input event to the first interface; means for capturing the event and sending the input event to the at least one further interface in parallel.

According to a third aspect of the present invention there is provided a computer program product stored on a computer readable storage medium, comprising computer readable program code means for performing the steps of: receiving a user input event for a first interface; capturing the event and sending the input event to one or more other interfaces in parallel; wherein the interfaces are for a single form of application provided on different configurations of software and/or hardware.

A link is provided between the GUI of a number of configurations (for example, GUI1 for configuration 1, GUI2 for configuration 2, GUI3 for configuration 3, etc.). When a test is run for a GUI of a first configuration (GUI1), the user events (keyboard/mouse) generated as part of the test are captured and automatically dispatched to all other GUIs for all other configurations (GUI2, GUI3, etc.). In this way, multiple GUIs receive the same user interface event in parallel.

### BRIEF DESCRIPTION OF THE DRAWINGS

Embodiments of the present invention will now be described, by way of examples only, with reference to the accompanying drawings in which:

FIG. 1 is a block diagram of a computer system in accordance with the present invention;

FIG. 2 is a detail of the computer system of FIG. 1 in accordance with the present invention;

FIG. 3A is a flow diagram of a process of testing in accordance with the present invention;

FIG. 3B is a flow diagram of a process of inputting events in accordance with the present invention; and

FIGS. 4A to 4D show a series of graphical user interface embodiments illustrating a testing process in accordance with the present invention.

### DETAILED DESCRIPTION

The present invention is described in the context of testing GUI applications provided on different configurations of software and/or hardware. The testing in the described embodiment is carried out remotely at a client system at which user interface events are generated. The client system communicates with the GUI applications under test via a network, for example, the Internet. However, the present invention may also be applied to testing of other forms of an application provided on different configurations carried out either remotely or locally to one or more of the application configurations.

The description is provided in the context of testing software applications; however, the proposed method and system could also be applied to testing other forms of data input.

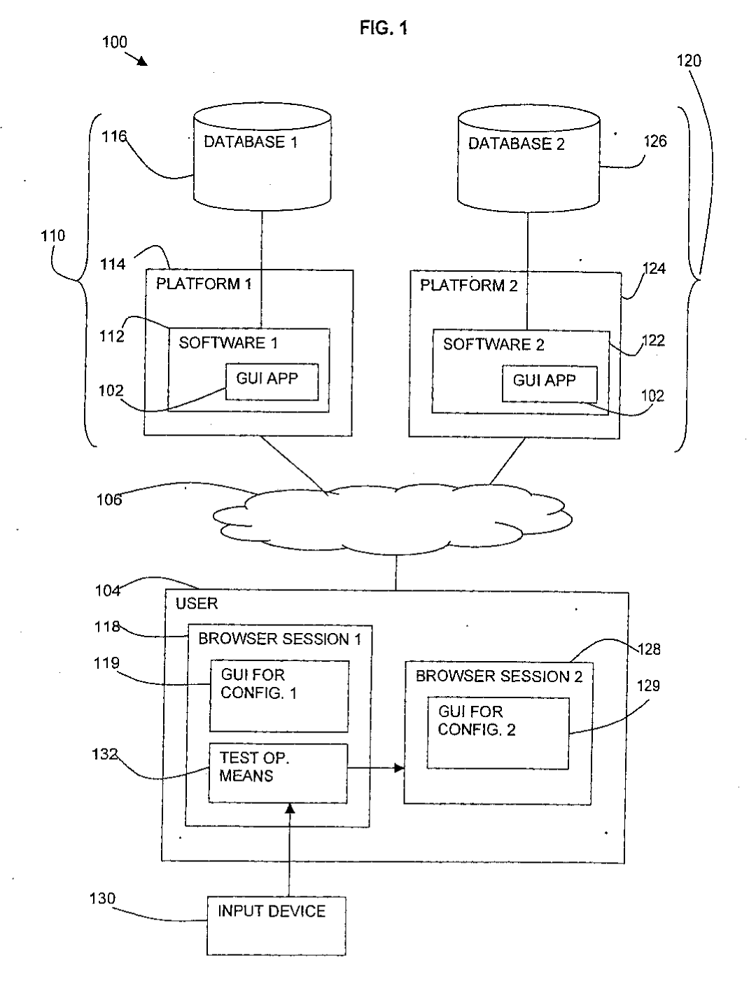

Referring to FIG. 1, an example embodiment of a computer system 100 is shown. A GUI application 102 is provided to be tested by a user at a client system 104 remotely via a network 106. In use, a GUI 119, 129 of the GUI application 102 is presented to the user via a browser application. For example, the network 106 may be the Internet and the browser application may be a Web browser.

The GUI application 102 under test is provided on a first configuration 110 of software/hardware stack. In the first configuration 110, the GUI application 102 runs on a first form of software 112 provided on a first form of platform 114 with access to a first form of database 116.

The GUI application 102 under test is also provided on a second configuration 120 of software/hardware stack. In the second configuration 120, the GUI application 102 runs on a second form of software 122 provided on a second form of platform 124 with access to a second form of database 126.

The GUI application 102 may be provided on additional third and subsequent configurations (not shown). Elements of the different configurations of software/hardware stacks may be the same in different configurations. For example, the forms of database 116, 126 may be the same with different platforms 114, 116 and software 112, 122.

As an example, in a first configuration 110, the GUI application 102 may be created by software 112 in the form of a web server such as IBM's WAS, installed on a platform 116 in the form of AIX, using a database 118 in the form of DB2. This results in a software/hardware stack for the GUI application of WAS/DB2/AIX. (IBM, WAS, AIX, DB2 are all trade marks of International Business Machines Corporation.)

As an example, in a second configuration 120, the GUI application 102 may be created by software 122 in the form of a web server such as BEA WebLogic, installed on a platform 126 in the form of LINUX, using a database 128 in the form of ORACLE. This results in a software/hardware stack for the GUI application of BEAWebLogic/ORACLE/LINUX. (BEA and WebLogic are trade marks of BEA Systems, Inc., LINUX is a trade mark of Linus Torvalds, and ORACLE is a trade mark of Oracle International Corporation.)

To test the GUI application 102, a test must be carried out on each configuration. Therefore, the test must be repeated multiple times, once for each configuration.

In the example embodiment shown in FIG. 1, the user carries out the tests on the GUI applications 102 provided on the different configurations 110, 120 from a remote client system 104 with each configuration 110, 120 having its own browser application session 118, 128. The first browser session 118 points to the first configuration 110 and shows the GUI 119 provided by the GUI application 102 on this first configuration 110. The second browser session 128 points to the second configuration 120 and shows the GUI 129 provided by the GUI application 102 on this second configuration 120.

A first browser session 118 is a master terminal and a user inputs test events using an input device 130, for example, such as a keyboard, mouse device, voice input device, touch pad device, or a combination of such devices.

A test operation means 132 is provided which may be an extension of the browser application or a separate application. The test operation means 132 captures the test input events in the first browser session 118 and dispatches the test input event to the other browser sessions 128 in parallel.

In a widows display environment at the client system 104, each browser session 118, 128 can be displayed in a separate window allowing the user to view the outputs of each test operation. The user can observer the operations working in the windows and can tell if the test has passed on each separate configuration.

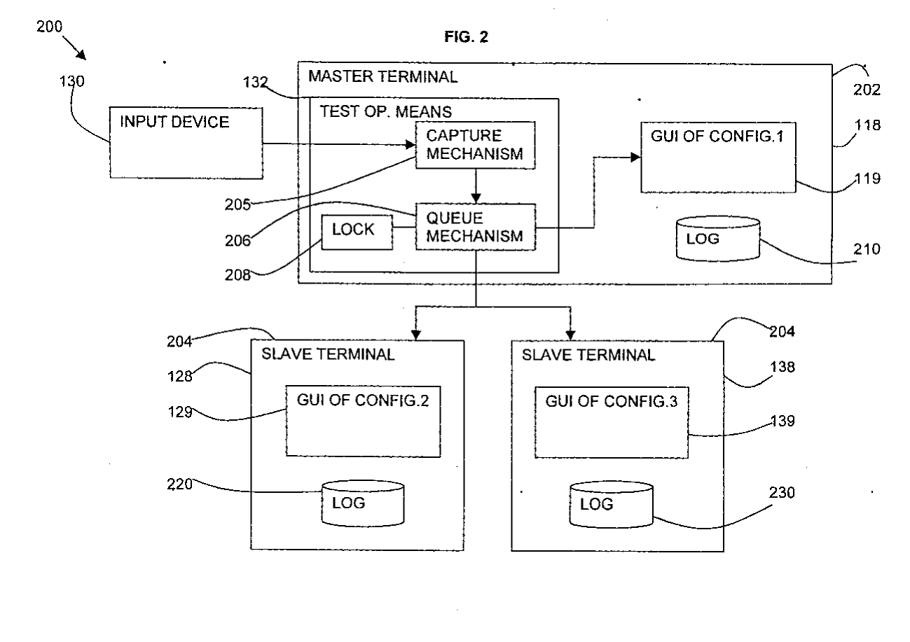

Referring to FIG. 2, a first embodiment of a browser arrangement 200 is shown. A first browser session 118 is a master terminal 202 and second and third browser sessions 128, 138 are slave terminals 204. Additional slave terminals may be provided. The browser sessions 118, 128, 138 may be sessions on the same or different browser applications.

GUIs 119, 129, 139 for different configurations of software/hardware stacks are provided, each on a different browser session 118, 128, 138. For example, the browser session may be session in a web browser pointing to URLs for different platform configurations.

Input events are generated by an input device 130, for example, in the form of keystroke inputs. The input events determine operations on the master terminal 202.

A test operation means 132 is provided. This may be an extension of the browser application on which the first browser session 118 is running or may be provided separately. The test operation means 132 includes a capture means 205 which captures the GUI operations a tests performs. The captured input to the master terminal 202 is sent by the test operation means 132 as simultaneous inputs to the slave terminals 204.

The capturing of the GUI operations can be implemented in a variety of ways. In one implementation, a new browser application can be written in which a recording application can receive all events. In another implementation, all events from within the operating system can be intercepted as they are displayed. In a third implementation, code is put into the GUI application at test time to stream the events to a recording application.

The captured input event may be relayed to the slave terminals at each keystroke or may be relayed when a defined action is taken such as pressing a button.

The test operation means 132 uses a queue mechanism 206. To synchronize the keystroke input to the master terminal 202 with each slave terminal 204, a locking mechanism 208 is implemented on the master terminal 202. The locking mechanism 208 freezes the input on the master terminal 202 until all the slave terminals 204 have returned following the previous input event. By “returned”, it means that the slave terminals 204 have completed refresh. This is necessary as each input event may be returned at a different rate due to the latency of the different software stacks.

The determination that each session has returned completely will be made not on positional verification (i.e. that certain characters have returned at a given position) but on a higher level of determination provided by the contents of the screen (for example, that there is a field with “Account Balance” somewhere on the screen with a non-blank value filled in).

Each browser session 118, 128, 138 has a log 210, 220, 230 to record GUI interactions for each GUI configurations 119, 129, 139. This can be by logging the HTML flowing. This means that a user can review the logs 210, 220, 230 to evaluate the operation of a GUI 119, 129, 139.

The interactions between each slave terminal 204 and the master terminal 202 can also be logged so that should an error occur, sufficient information is available to determine the cause of the error.

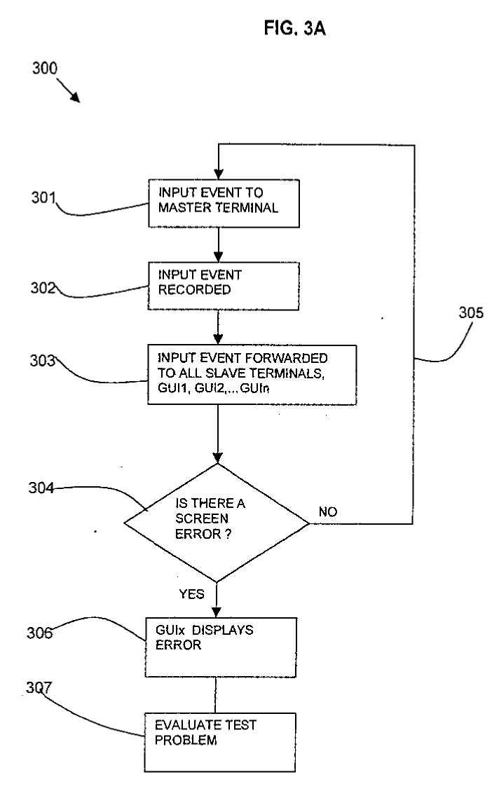

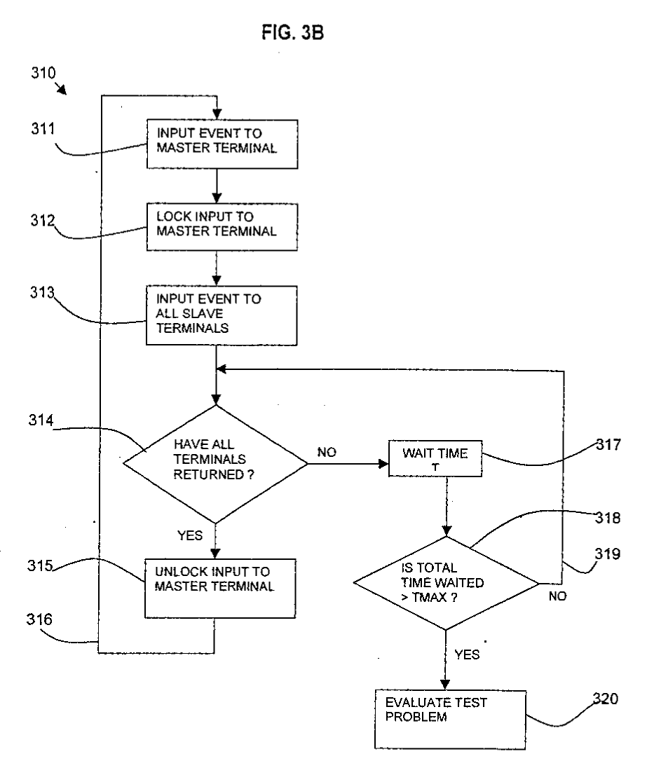

FIG. 3A shows a flow diagram 300 of the test process. A user inputs an event on a master terminal 301. The key stokes of the input event on the master terminal are recorded 302. The recorded key stokes are forwarded to the slave terminal, GUI1, GUI2 . . . . GUIn 303.

It is determined 304 is there is a screen error displayed for any of the terminals. A user may be required to validate each screen under test unless an automated process is configured to do some of the validation. If no error is displayed 305, the process returns to the input step 301. If one or more of the GUIs (GUIx) displays an error 306, the user observes the error screen and the problem is investigated.

FIG. 3B shows a flow diagram 310 of the process of inputs to a master terminal and slave terminals. An input event is made to the master terminal 311. A lock is put on the master terminal 312 to prevent further inputs. The input event is made to all slave terminal 313. It is then determined if all terminals have returned 314. If all terminals have returned, the lock is removed from the master terminal 315 and the process loops 316 to the next input event.

If it is determined 314 that not all the terminals have returned, a given time t is waited and it is determined if the total time waited since the input events exceeds a maximum time 318. If the maximum time is not exceeded, the process returns to determine 314 if all the terminals have now returned. If the maximum time is exceeded, the user needs to evaluate 320 the terminal to determine the problem.

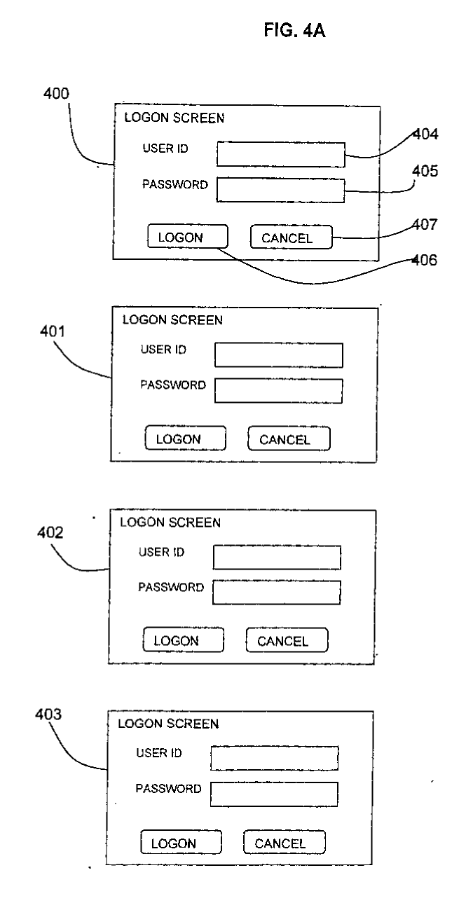

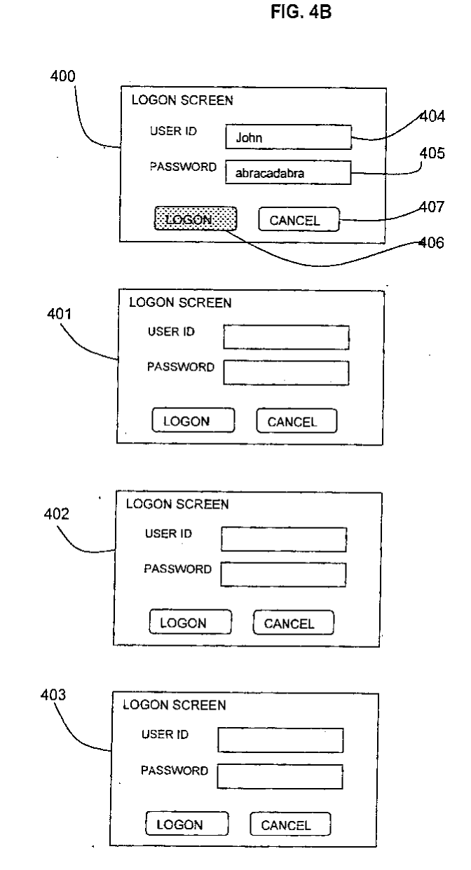

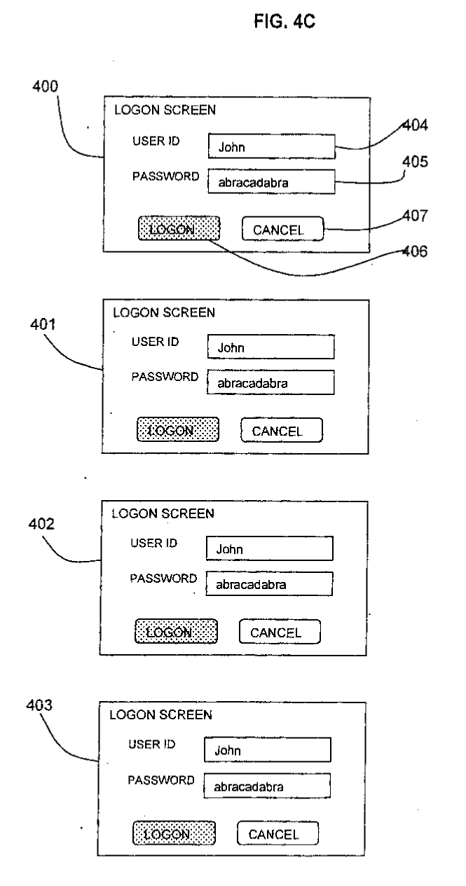

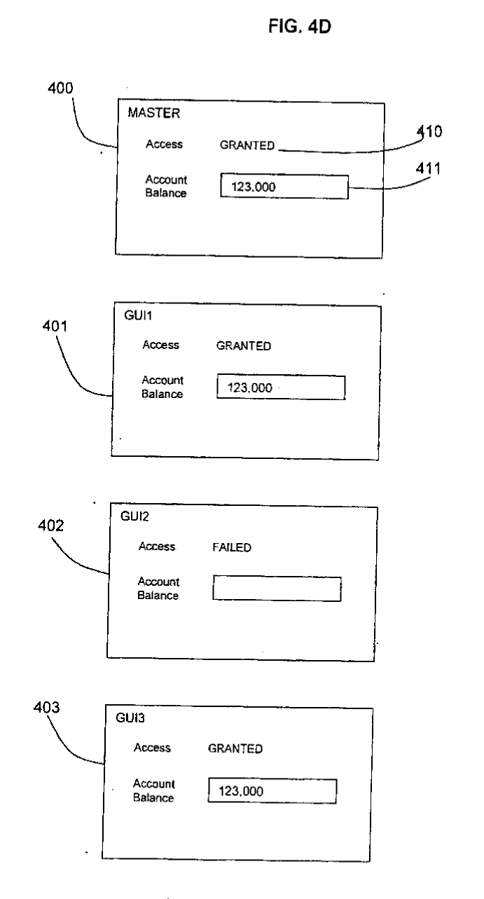

Referring to FIGS. 4A to 4D, the described method is illustrated by a simple logon GUI. From the master terminal, the GUI events are captured and translated into a pseudo language which represents the essence of what has been done on the master terminal. This pseudo language is then used to send GUI events to slave GUI terminals. The instructions are simultaneously sent to the slave GUI terminals.

There are three stages which are detailed below:

1) Master GUI terminal is captured using a high level pseudo language.

2) High level pseudo language is immediately used to send to slave GUI terminals.

3) GUI 1 has succeeded, GUI 2 has failed, and GUI 3 has succeeded.

FIGS. 4A and 4B show the first stage. FIG. 4A shows a master terminal 400 and three slave terminals 401-403. Each of the terminals 400-403 is in the form of a logon screen with an entry field for the user id 404, an entry field for a password 405, and click buttons for log on 406 and cancel 407.

FIG. 4A shows the starting stage in which each of the master terminal 400 and the slave terminals 401-403 are awaiting input.

The user id “John” is entered in the user id field 404 on the master terminal 400 and the password “abracadabra” is entered in the password field 405 on the master terminal 400. The log on button 406 of the master terminal 400 is clicked. FIG. 4B shows these inputs.

A capture mechanism reduces the inputs to the master terminal 400 to a flow of calls to the underlying application:

Set window focus to (MASTER, “Logon”);

Enter Text (MASTER, field1, “John”);

Enter Text (MASTER, field2, “abracadabra”);

Click_button(MASTER, “button 1”);

This pseudo language is generated when the user on the master terminal 400 presses the log on button 406.

At the next stage, the high level pseudo language is immediately used to send to the slave terminals 401-403.

A forwarding mechanism sends these events to the slave terminals simultaneously as pseudo GUI events:

Set window focus to (GUI1, “Logon”);

Enter Text (GUI1, field1, “John”);

Enter Text (GUI1, field2, “abracadabra”);

Click_button(GUI1, “button 1”);

Set window focus to (GUI2, “Logon”);

Enter Text (GUI2, field1, “John”);

Enter Text (GUI2, field2, “abracadabra”);

Click_button(GUI2, “button 1”);

Set window focus to (GUI3, “Logon”);

Enter Text (GUI3, field1, “John”);

Enter Text (GUI3, field2, “abracadabra”);

Click_button(GUI3, “button 1”);

As shown in FIG. 4C, this sends the GUI events to the slave terminals 401-403 which are under test.

In this example, it is assumed that GUI2 will fail to log John onto the system due to an error on the second system.

The results are returned:
Master Terminal access is granted.
GUI 1 access is granted. Balance is returned.
GUI 2 access is denied.
GUI 3 access is granted. Balance is returned.

This is shown in FIG. 4D in which each of the master and slave terminals 400-403 have a field indicating the status 410 and a field showing an account balance 411.

A record mechanism would record this as:

Text Returned (GUI1, field3, GRANTED);

Text Returned (GUI1, field4, 123,000);

Text Returned (GUI2, field3, FAILED);

Text Returned (GUI2, field4, ″″);

Text Returned (GUI3, field3, GRANTED);

Text Returned (GUI3, field4, 123,000);

This shows how a mechanism can be implemented by deconstructing the GUI events into a higher level pseudo code which can then be simultaneously sent to GUI's which are running on different software stacks.

In a second example embodiment of a browser arrangement, the slave terminals are virtual slave terminals in that they are not displayed to the user. In some situations, the rendering of the GUI for an application supported by different configurations may be different. For example, HTML generated by different web servers (for example, WebSphere, BEA WebLogic, etc.) may look the same but there are slight differences in the rendering. Depending on how the system is configured, the GUIs may have a different look and feel (sometimes called a “skin”).

In this second embodiment, a higher level application is created which examines the different parts of the HTML returned and determines which fields are common. Given the position and title of an input field on one version of the HTML, the application can determine the corresponding position and title of the HTML input field generated by the other web server.

In this way, comparison is performed at the level of the HTML generated by the GUI applications on the different configurations at the backend to the virtual slave terminals.

In an optional addition to the second embodiment, the virtual terminal may be rendered as a display where the process detects differences in the execution of the GUI represented by the virtual terminal. In this way, the error feedback comes to the tester at a convenient interactive test time.

The advantages of the master and slave terminal system include a reduction in testing by a significant multiplier, a reduction in repetition of work and duplication of data.

The system could also be used for pre-configuring large amounts of data into a GUI front ended system. One application of a test system is to load data into a system automatically via a GUI. For example, the aim may be to create a system with 100 customer accounts all created via a GUI. The record process at the master terminal would capture the user's interactions of a single GUI and simultaneously send these to the 99 GUI windows, but would vary input fields such as, for example, the account number, to provide 100 customer accounts. The user on the master terminal can specify which bits of data are automatically changed.

The present invention is typically implemented as a computer program product, comprising a set of program instructions for controlling a computer or similar device. These instructions can be supplied preloaded into a system or recorded on a storage medium such as a CD-ROM, or made available for downloading over a network such as the Internet or a mobile telephone network.

Improvements and modifications can be made to the foregoing without departing from the scope of the present invention.

1. A method for simultaneous testing of applications, comprising:
receiving a user input event for a first interface;
capturing the input event and sending the input event to one or more other interfaces in parallel;
wherein the interfaces are for a single form of application provided on different configurations of software and/or hardware.

2. A method as claimed in claim 1, wherein the interfaces are graphical user interfaces (GUIs).

3. A method as claimed in claim 2, wherein the GUIs are provided on browser application sessions at a user system.

4. A method as claimed in claim 3, wherein the user system communicates via a network with each of the applications provided on different configurations.

5. A method as claimed in claim 4, wherein the GUIs are provided on web browser application sessions pointing to different Universal Resource Locators (URLs) for the applications on different configurations.

6. A method as claimed in claim 1, wherein the one or more other interfaces are virtual interfaces which are not displayed to the user.

7. A method as claimed in claim 6, wherein a virtual interface is rendered as a display when a difference between the outcome of the input event on the first interface and the virtual interface is detected.

8. A method as claimed in claim 1, wherein input events to the first interface are locked until the input event has returned for all the interfaces.

9. A method as claimed in claim 8, wherein an input event is returned in an interface when a content of the interface is detected.

10. A method as claimed in claim 1, wherein logs are maintained of input events and processing on each interface.

11. A system for simultaneous testing of applications, comprising:
a first interface for an application provided on a first configuration of software and/or hardware;
at least one further interface for an application of the same form as the application of the first interface provided on a different configuration of software and/or hardware;
an input device for inputting a user input event to the first interface;
means for capturing the input event and sending the input event to the at least one further interface in parallel.

12. A system as claimed in claim 11, wherein the interfaces are graphical user interfaces (GUIs).

13. A system as claimed in claim 12, wherein the GUIs are provided on browser application sessions at a user system.

14. A system as claimed in claim 13, wherein the user system communicates via a network with each of the applications provided on different configurations.

15. A system as claimed in claim 14, wherein the GUIs are provided on web browser application sessions pointing to different Universal Resource Locators (URLs) for the applications on different configurations.

16. A system as claimed in claim 11, wherein the at least one further interface are virtual interfaces which are not displayed to the user.

17. A system as claimed in claim 16, wherein a virtual interface is rendered as a display when a difference between the outcome of the input event on the first interface and the virtual interface is detected.

18. A system as claimed in claim 11, including a locking mechanism for input events to the first interface for locking until the input event has returned for all the interfaces.

19. A system as claimed in claim 18, including means for detecting when an input event is returned by an interface by detecting a content of the interface.

20. A system as claimed in claim 11, including logs of input events and processing on each interface.

21. A system as claimed in claim 11, wherein the system is an extension of a browser application.

22. A computer program product stored on a computer readable storage medium, comprising computer readable program code means for performing the steps of:
receiving a user input event for a first interface;
capturing the input event and sending the input event to one or more other interfaces in parallel;
wherein the interfaces are for a single form of application provided on different configurations of software and/or hardware.
